(19) United States
(12) Patent Application Publication
(10) Pub. No.: US 2011/0162967 A1
(43) Pub. Date: Jul. 7, 2011

(54) ION EXCHANGE ELEMENT, SPACER COMPONENT, AND DEVICES MADE THEREFROM

(75) Inventors: Russell J. MacDonald, Wilmington, MA (US); Zhang Li, Belmont, MA (US)

(73) Assignee: GE IONICS, INC., Watertown, MA (US)

(21) Appl. No.: 13/046,338

(22) Filed: Mar. 11, 2011

Related U.S. Application Data
(62) Division of application No. 11/293,441, filed on Dec. 2, 2005, now abandoned.
(60) Provisional application No. 60/632,842, filed on Dec. 3, 2004.
(60) Provisional application No. 60/632,844, filed on Dec. 3, 2004.

(51) Int. Cl. B01D 61/46; B01D 15/04

(52) U.S. Cl. 204/638; 210/435; 210/486

(57) ABSTRACT

A linear exchange element with functionalized polymer on a core of rope, twine or yarn has well defined physical structure and may function as a spacer or be formed into free-standing exchange elements. A screen is fabricated from such strands or strips, with a pattern of mixed, sequential or other exchange types for enhanced operation in a capture device or in an electrodialysis device. Strands possess tensile strength, enabling deionization devices of new architecture, such as fiber-wound cartridges and other packing arrangements. Bodies made of the strands may operate as walls to perform the function of an exchange membrane or bed, or may operate as spacers positioned between membranes to enhance ion capture and transport, and their properties simplify handling and regeneration. Electroseparation devices advantageously employ the open spacers to better treat food, fermentation product or other streams where high conductivity, suspended solids and fouling would otherwise present problems. “Woven” mats may be arranged so that strands of one type in a first layer possess at least some points of contact with strands of opposite type in an adjacent layer, and different strand diameter and mesh pitch or dimension may be employed for treating fluids of different viscosity or concentration to optimize treatment throughput and removal rate, or to minimize fouling or flow obstruction and otherwise extend the range of treatment parameters.

### CROSS REFERENCE TO RELATED APPLICATIONS

This application is a divisional application of U.S. patent application Ser. No. 11/293,441 filed Dec. 2, 2005 and claims the priority benefit of U.S. Provisional Patent Application Ser. Nos. 60/632,842 and 60/632,844, each of which was filed on Dec. 3, 2004, each of which is hereby incorporated herein by reference.

### TECHNICAL FIELD

The present invention pertains to ion exchange material, and to devices employing ion exchange material. More particularly, it applies to strands of ion exchange material, and to mesh, fabric or screen made from such strands, as well as to fluid treatment devices employing ion exchange strand, mesh or screen materials.

### BACKGROUND

Ion exchange material made of synthetic polymer is widely used to treat and remove ionizable components from fluids, for example, to demineralize or alter the pH of water, to debitter whey, or to acidify, decolorize, desalt or sweeten various juices, fermentation products or otherwise modify various process fluids. Flow-through beds, or flow-through devices for fluid treatment may employ exchange material or components in the form of grains, fabrics or membranes. Certain membranes employing thin surface films may act as filters exhibiting both charge- and size-exclusion characteristics. Membranes of a pure ion exchange type may be homogeneous, formed by the exchange-functionalization and polymerization of precursor material, or may be heterogeneous, formed as composites using powdered already-manufactured homogeneous exchange material(s) in a matrix of non-functionalized binder. Such heterogeneous membranes may also bear a thin surface film formed of homogenous material to further alter their characteristics. Granular ion exchange beads, while typically homogeneous polymers, may also be formed as composites, or even as aggregates containing components of several different exchange types, as well as so-called short-diffusion-path beads in which exchange functionalization or effective porosity is limited to the surface of the beads. Production of the various types of exchange material may require highly specialized machinery. Beads are often produced by a vibratory spray mechanism, while equipment such as a centrifugal spinarette of the type used to make synthetic fibers may be employed to produce ion exchange fibers. Other fiber- or textile fabrication technologies, such as electroflocculation, spinning and weaving may be employed to form felts, yarns and woven or non-woven fabric from the basic fibers produced in this manner For larger ion exchange structures such as membranes which are required to be free of defects and act as fluid separation barriers, it is common to internally reinforce or externally support the membrane by a fabric or mesh material. This mesh, however, is not exchange functionalized itself, but is typically formed of a polymer selected for its strength, workability and/or its durability in the intended process environment.

It is generally desirable to produce ion exchange components having high structural integrity, e.g., having substantial strength and not prone to developing looseness or faults that might result in unintended or excessive cross-leakage, i.e., passage of the untreated feed or return of the already removed ionic components.

However, mechanical limitations are to be expected in applying an exchange material to form a particular component or structural element, because the exchange material must typically have a certain water content, either as a gel or as a macroporous material, to accommodate the basic transport and exchange phenomena of an ion exchange medium, and such materials may thus be structurally weak, prone to leakage or otherwise possess poor mechanical properties. This problem may be compounded by the fact that exchange media undergo relatively large changes (for a solid) in dimension and modulus upon wetting and/or upon changing functional state. In addition, when exchange material is to be incorporated in a composite to achieve a special shape (such as a flat membrane) or acquire strength or structural integrity, thermal susceptibility and physico-chemical characteristics of the underlying exchange material may limit the type of binder material that can be successfully employed, or may limit the forming processes that may be utilized to fabricate components. For example, heat sensitivity may limit acceptable polymers to ones having a relatively low extrusion melt temperature, while the surface energies of binder and active material may dictate limitations on cross leakage. The binders may be relatively soft and flexible polymers, and membranes are, in any event, flexible, so practical devices, such as membrane-based electrodialysis devices, also require inter-membrane spacers to provide support and sealing, and to prevent adjacent membranes from contacting each other or occluding flow during device operation.

Generally, the spacer material employed in an electrodialysis device, whether in the form of a screen, array of ribs, an intermembrane exchange bead filling, a support lattice or some combination of these elements, must be configured to permit a fairly open and unobstructed flow. Thus, packed beads must be of a size that provides permeation spaces large enough to avoid excessive fluid drag, and structural elements like ribs and screens must both be rigid enough to maintain membrane separation, and be shaped so as to permit relatively unimpeded cross flow. A screen may also be configured to enhance mixing at the membrane surface so as to prevent loss of transport due to ionic screening.

Electrodialysis devices generally rely on relatively thin flow chambers to channel the liquid being treated into intimate contact with ion exchange membranes, through which the captured ionic components are driven by electrical potentials into separate channels. In a filled cell construction—one having ion exchange material in the flow path between adjacent membranes to increase the rate of capture and ion removal—the filling must simultaneously satisfy a number of constraints if performance is to be optimized. In practice, the inhomogeneous distribution of ion current, of fluid drag and flow, of bead sizes and packing, and the distribution of exchange types within the bead mixture may all influence the overall level of treatment quality. As cell dimensions are decreased, and the relative flow-path or bead distribution variations become more pronounced, treatment quality may be susceptible to greater variation, may become incapable of predictive modeling, or may suffer unanticipated flow channeling, device scaling or fouling, burning or obstruction.

Fabrication of treatment devices has generally followed the available forms of exchange material, relying largely on sheets and beads. Ion exchange felts have seen some use, and various people or commercial entities have proposed forming device housings of a more structural exchange material, loading beads in sachets or cells of exchange material to facilitate assembly or change-out, or even forming a sponge-like exchange material to provide enhanced exchange, assembly or cleaning properties. Device construction has tended to address structural and electrochemical functional aspects separately.

For example, some electrodialysis devices are constructed with a layered arrangement of sheets or plates, e.g., of ion exchange membranes, that constitute flow cells. A number of such cells are positioned between two electrodes such that when a fluid is passed through the device, ions are captured from the fluid by the exchange material and transported as an ionic current across the membranes. The membranes separate the overall device into treatment cells (which are fed by a flow of feed fluid), and adjacent cells that receive the ionic material removed from the treatment cells. In a two-chamber architecture, these are called the dilute and concentrate cells, respectively. This terminology apparently carries over from the early history of electrodialysis, when the feed was rendered more “dilute” by driving impurities, such as dissolved mineral salts, into the adjacent ion-receiving cells, which were allowed to run at lower flow rates and maintain a higher concentration of dissolved solids (hence good electrical conductivity). More generally, however, the removed material may be an ionizable impurity (such as hardness ions) or a desired product (such as an organic acid). In practical systems, one or both sets of cells may be operated in either a single-pass or recirculating mode, depending on overall design of the device and properties of the fluid that is to be treated. The outflow of the dilute cells may be a product stream, or a waste stream or may alternate in different operating cycles between producing product and waste, depending on the materials and processes involved. Furthermore, the electrical and fluid connections may be set up in some devices to allow periodic reversal of the flow or the electrical fields, interchange of the dilute and concentrate cells or other refinements of operation. In so-called electrodeionization (EDI) devices, at least the dilute cells generally contain a filling of ion exchange beads, felt or other ion exchange material positioned in the flow path. This material operates as a stationary medium to strip ions from the solution and to provide ion-conductive pathways along which captured ions are driven by the electric field to, or toward, the adjacent membranes. General purpose EDI devices typically contain a mixed exchange filling (such as a mixture of both anion- and cation-exchange beads), so ions of each type are stripped from the fluid by the corresponding exchange bead, possibly being re-emitted and at bead-to-bead junctions, drifting in the flow and being recaptured, but generally and ultimately passing through one of the bounding ion exchange membranes into an adjacent concentrate cell. Reference is made to commonly-owned PCT international patent applications published as WO 2004/024992 and WO 2005/042808, each of which is hereby incorporated herein by reference, for further descriptions of the technology and details of device construction.

Much has been written concerning the physics and rate equations governing operation and ion-removal efficiency of these devices, and concerning characteristics of different layers or mixtures of, and types of exchange and other beads that may be employed in the flow path. The principal effects to consider in the mechanisms of electrodeionization treatment involve diffusion in the fluid across the thin boundary layer at any boundary between the fluid and a bead or membrane surface; ionic transport through a bead; re-release at a bead surface, or passage into an adjacent like-type bead or membrane, and, when the packing results in re-release before reaching the membrane, one must also consider the intermediate steps and delays attendant upon migration of the released material back into the flow, its re-capture, and eventual ionic travel to and through the membrane into the adjacent cell. For some impurities that may be present in the flow, or for certain less selective exchange membranes, one must also consider back-diffusion from the concentrate cell into the dilute cell.

Ion exchange material is generally quite swellable, bead packing efficiencies vary with size and size distribution of the beads, so filling a large thin cell (which may, for example, have nominal dimensions of a rectangular parallelepiped 5 inches by 40 inches by 1/4 inch) without occluding flow may be quite difficult. This factor, and the sensitivity of the permeation space to all manner of fouling, occlusion and flow channeling, has tended to prevent the application of filled-cell constructions to treatment of organic or biologically-derived fluids.

Putting aside such considerations, however, on a theoretical basis, in these devices, the diffusion of the material present in the feed fluid through a thin laminar layer to the surface of the exchange material may be a rate-limiting step in the ion removal process. By increasing flow velocity, this boundary layer can be made thin, and/or turbulent mixing can otherwise be made to occur so as to maximize transfer at the fluid/solid boundary.

Historically, electrodialysis (ED) with unfilled cells preceded the development of filled cell electrodeionization. In unfilled (ED) devices, certain spacer screens have been employed to provide turbulent mixing at the surface so as to provide the thinnest possible stationary layer and thus enhance ion transfer even at moderate or low overall fluid flow velocities. In filled cell electrodeionization (EDI) devices, the transfer rate is greatly enhanced in the dilute cells because the presence of ion exchange material presents a surface area for capture of ionic species that is much greater than that of the bounding membranes, and the bead surfaces are positioned directly in, rather than adjacent to, the flowing stream. Operation at an electrical current effective to maintain the beads in a substantially regenerated state also improves the removal rate, since the regenerated exchange material actively dissociates and captures ionizable material that is present in the feed stream. Thus, with ample capture capacity, filled cell EDI has generally been concerned more with the negative effects of flow occlusion, than with imparting some source of turbulence. In an EDI device, regeneration of beads occurs primarily due to water splitting, e.g., at contact points of beads or bead-membrane junctions of opposite exchange types, called heterojunctions. At such heterojunctions, however, the ion conduction path through the exchange medium is disrupted, and already-captured material may be ejected back into the fluid stream. The nature of the packing may therefore influence the background or residual level of ions that remain present in treated material.

In addition to overall removal rate, for many applications (such as the production of ultrapure water or other fluid) it is desirable to achieve process completion or a high removal end point. Various stochastic arguments and Monte Carlo simulations indicate that, by employing relatively thin dimensions of the cells to limit the number of heterojunctions which occur along the ion transport path through the filling and adjacent membrane, one can reduce re-emission of the removed solids and may thus potentially enhance removal rates and lower the residual ionic content of the treated fluid. This is described in the aforesaid International Application WO 2004/024992. However, many factors must be addressed in designing an electrodialysis device, and employing thinner chambers with fewer beads may also alter the effective fluid flows, increase the chamber back-pressure, lead to regions of poor electrical current distribution across the flow area, reduce the exchange contact area presented to the flow, and change the energy usage or efficiency, thus affecting the operating characteristics of the system. It is therefore desirable to provide an improved construction for an electrodialysis device.

From the foregoing discussion, it is apparent that the existing forms of bulk ion exchange material have limitations, and that there remains a need for additional forms of exchange material to better address desired electrochemical and physical characteristics of a treatment device.

It would therefore be desirable to provide a new ion exchange material or component.

It would also be desirable to provide such material or component having a well-defined, stable and predictable form.

It would also be desirable to provide such material as a removable and replaceable, or regenerable, component of a demineralizing or electrodialysing device.

### SUMMARY OF THE INVENTION

One or more of these and other desirable traits are provided by an ion exchange component formed as a strand or strip comprising exchange functionalized polymer polymerized or cross-linked around a flexible core, e.g., a rope, twine or yarn, which may be of a dissimilar material, to form a linear exchange element having both structural and ion exchange properties. The component is preferably hard but flexible, and may itself function as a spacer or as a free-standing active element, or be further worked into new ion exchange configurations. A spacer in the form of a mesh or screen may be fabricated from such strands or strips. The spacer so formed has a well defined shape and precise distribution of ion exchange material; in an electrodialysis device, may be placed in a fluid stream to capture material from a feed fluid, carrying out the electrochemical function of a packed, or packed and layered or striped, exchange bead filling, with a precisely determined distribution of exchange types and activity. A device may employ such a web or sheet formed with its strands of functionalized material extending transverse to the general plane of the sheet to optimize ion transport pathways in an electrodeionization cell.

Ion exchange functionalized strands of the invention may be formed by wetting or coating a thread or rope (for example a polyester, polyamide, polyolefin or other twine) with a combination of exchange polymer precursor agents (e.g., monomer, cross linking agent and exchange functionalizing agent), and passing the wetted strand through a cross-linking/polymerizing arrangement, such as a through a heated tube or oven, or through irradiating region, for a time sufficient to cure the precursor material. A heated tube may be sufficiently small to effectively constrain the wetted rope, imparting a smooth or calendered and precisely dimensioned surface contour. The exchange-functionalized and cross-linked item so produced is a thin flexible rod or strand. Such a heated curing tube may operate to exclude air during polymerization, to better assure that the mixture attains the intended exchange capacity during the controlled cross-linking and polymerization reactions which occur as it cures.

The externally exchange functionalized strand so produced may have tensile strength greater than that of the underlying exchange polymer, and may possess a stiffness generally greater than the underlying fiber material, allowing the ion exchange strand to be worked or fashioned into diverse new and useful components and shapes. Moreover, because the surface region is the functional portion of the strand, the strand possesses a short diffusion path, like that of thin-shell exchange beads. The localization of functionality in a surface layer provides enhanced exchange transport characteristics that are advantageous in electrodeionization devices, described below, and in store-and-release treatment operations.

In one embodiment of a treatment device formed with such exchange strand, the strand is wound about a cylindrical core to form a cylindrical permeable ion exchange body that separates an inside region from an outside region. The core may be placed within a cylinder or other vessel which has ports or plumbing to provide a flow into one side of the winding and out from the other, demineralizing the fluid as it crosses the winding. A device having this construction may replace a familiar ion exchange resin bottle or cartridge with a structure similar to an oil filter or reverse osmosis module. The exchange element, i.e., the wound core, has a high degree of integrity, retains its physical form, and may be regenerated, in situ or in a separate operation, without the complexities of removal, flotation or separation and the like that are encountered with regeneration of used exchange beads.

In another embodiment, strands of the material are fabricated into a screen or spacer, and the spacer is placed within a flow cell of an electrodialysis device, such as a dilute (or desalting) cell of the device. The strand contacts and supports a membrane constituting one wall of the cell, and, unlike conventional ED spacers, also serve as an ion-conduction pathway directly into the membrane. Such a spacer may be employed in a spiral wound embodiment configured with internal and external electrodes, anion and cation exchange membranes, and hydraulic connections to form a spiral EDI device. In this case, the strands or screen spacer fulfill the function of an exchange bead filling or packing. They maintain a proper membrane spacing, permit bulk fluid flow within cells of the device parallel to the membrane surface, and capture and transport ions in the fluid, to and across the membranes. The strands may be of different exchange type. Thus, by proper selection of the weave or mesh pattern of the different strands, one achieves exact control over the position, contact area and amount of each exchange material.

In yet other embodiments, the strand may constitute a rod of exchange material that is immersed in a flow path, such as a simple cartridge or a segment of a conduit, to demineralize fluid therein. This aspect of the invention may be of particular utility for specialized applications in analytic instrumentation, for example, to condition water or another fluid for a measurement instrument that requires a softened, demineralized or otherwise treated water in relatively small quantity. In yet other applications, the exchange strand may be sized and shaped to constitute a seal (like an O-ring or a sealing bead) or a packing, or may be packaged as a tangled bed in a device like a depth filter that simultaneously removes dissolved and suspended solids.

### BRIEF DESCRIPTION OF THE DRAWINGS

The invention will be understood by those skilled in the art from the description herein of several embodiments and illustrative details of construction, and some of its desirable variations and features, together with figures thereof, wherein:

FIG. 1 is a schematic perspective view of a system for making exchange elements in accordance with one embodiment of the present invention;

FIG. 2 shows details of a draw-polymerization stage useful in the fabrication system of FIG. 1;

FIG. 3 is a schematic perspective view of one fluid treatment device in accordance with the invention which may be made from the exchange elements of FIG. 1;

FIG. 4 is a schematic perspective view of a detail of a first embodiment of a spacer for a deionization device in accordance with another aspect of the present invention showing strand orientation; and

FIG. 5 shows another spacer embodiment with several layers.

### DETAILED DESCRIPTION

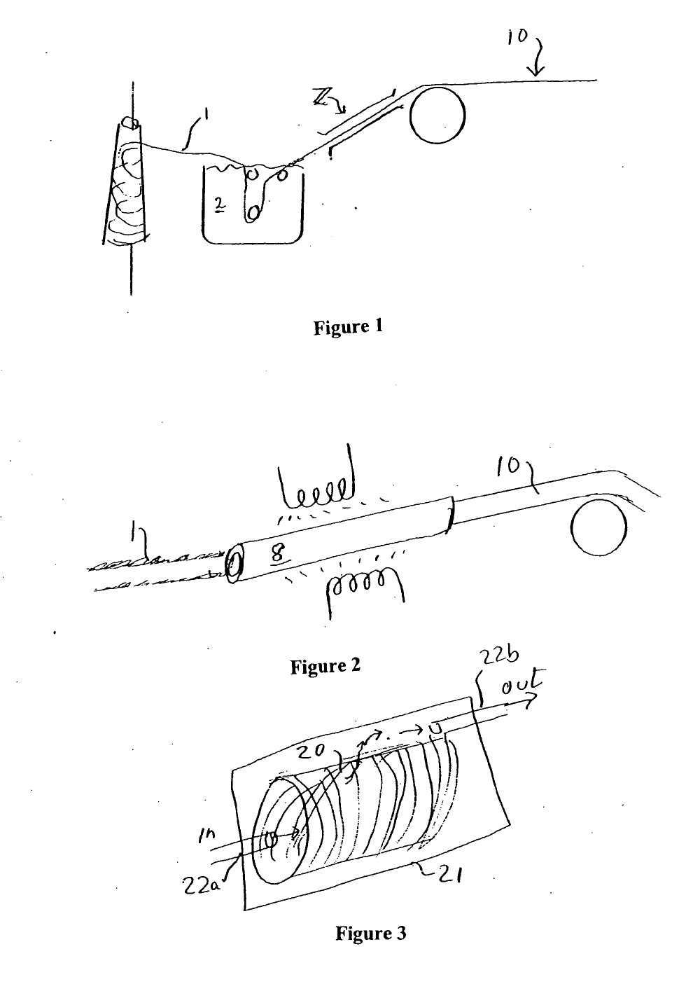

As shown in FIG. 1, a strand 10 according to the invention is made by providing a core 1, which by way of example may be a twine, yarn, rope or strip made of polyolefin or other material, and wetting or covering the core 1 with an unpolymerized combination or mixture of precursor exchange polymer material 2. The material 2 may be any suitable mixture of materials capable of curing into an ion exchange polymer. Suitable mixtures may be found in the literature of ion exchange resins or membranes, either anion- or cation-exchange type, and need not be specifically described here. Typically, the precursor mixture includes one or more monomers, an exchange functionalizing agent, and a cross-linking agent. Materials, such as a solvent, cross-linking accelerant, pore-former or other conditioning agent may also be added. Applicant generally believes that any suitable formulation of synthetic polymer ion exchange material will be suitable for this aspect of the invention.

Preferably, the strand 1 is a material that is compatible with high purity fluid treatment, e.g., that does not leach or bleed noxious or incompatible solvents or residual components, and that is also compatible with—able to pick up, hold, wet with or adhere to—the precursor material. String, yarn, rope or twine of a polyolefin such as polypropylene are one suitable, inexpensive and widely available core material. Polyamide, polyester and other strands may also be used. It is preferable that the strand have a rough or hairy surface to enhance coating adhesion, and/or that the strand be of a multi-fiber construction to enhance intrafiber capillary wicking, wetting and ultimate adhesion and retention of the precursor mixture. The strand is then coated by any suitable means.

As shown in FIG. 1, coating may be accomplished simply by soaking or running the core 1 through a tank of the mixed precursor material, optionally after a co-solvent rinse or other treatment to enhance wetting. Vibratory energy may also be applied to accelerate wetting.

The wetted core then passes into a polymerization/cross-linking zone Z, where it is cured. Curing may be effected at ambient temperature by allowing enough time in the zone for effective cross-linking, or curing may be expedited by providing heat or irradiation to drive the polymerization reaction.

After passing through a polymerization zone, the resulting exchange strand has hardened sufficiently that it may be handled—e.g., respooled for storage in bulk or passed to later a fabrication stage for incorporation into an active ion exchange device.

Notably, the exchange strand has a core of preferably inert but high tensile strength material, and an external shell of ion exchange polymer. The diameter of the starting strand or twine 1 may be selected within a broad range—less than 0.1 mm to greater than 1 mm diameter, depending on an intended use, while the material added and polymerized in the later steps provides a shell or body of exchange material of a desired type having a controlled thickness for different applications.

In one embodiment, the coated strand is cured by drawing it into a heated and close-fitting tube 8 that calenders the wet, irregular or wooly-surfaced wetted strand 1 into a smooth-surfaced well-dimensioned rod 10. The tube may be selected to have dimensions as small as or somewhat smaller than the rough wetted fiber, so that it squeezes the wet strand, excludes bubbles and voids, and also operates to exclude atmospheric air during polymerization. The latter step results in a finished rod or strand with higher exchange capacity than would be obtained with air-curing. Instead of a tube, a heated press plate or rotating forming wheels may be used, or the surface may be pressed by such wheel or form and then immediately set or cured in its smoothed state.

Once cured, the strands may be rinsed if necessary.

Cured or semi-cured strands 10 may pass to a further fabrication process, such as a mesh-forming process, a weaving process, a process wherein the strand is incorporated into a device and/or shaped and further cured, or other process.

Strands of the present invention may also be wound into structures, such as a circumferentially wound about a frame to form a cylindrical shell 20, as shown in FIG. 3, that may be mounted within a vessel 21 such that fluid entering the interior at a port 22a either loses ions to fluid outside the shell in line 22b (when arranged with electrodes to form an electrically-driven deionization cell), or such that the fluid itself passes through the winding 20 and is demineralized, softened or shifted in pH before passing out line 22b. In the latter case, the strand functions as an ion exchange resin. In this connection, the enhanced integrity and tensile strength of the strand permits it to assume the structural shell shape. The wound shell element may then be regenerated in situ (for example by passage of suitable brine or reagents) through the surrounding vessel 21. Several shells of different exchange material may be nested together to increase total capacity or to achieve a desired demineralization of the feed fluid. In that case, when different fluids are required for regenerating two different exchange materials, each wound shell may be separately removed and regenerated (e.g., by dipping in a suitable acid, base or salt regen solution). Advantageously, the integral structure may be handled, regenerated, rinsed, even pressurized or dried, without any of the problems such as shock cracking and separation of float, that would be encountered in the regeneration of ion exchange resin beads.

Strands made in accordance with the present invention may also be fabricated into tangled beds to form a treatment device which act like a microfiltration depth bed to physically capture suspended particles and also to strip ions from solution.

Strands made in accordance with the present invention may also be fabricated into screen or spacer elements, providing a two-dimensionally extending sheets of defined thickness that also possesses ion exchange properties and openness to flow. Such a screen element may be used as the spacer element between two sheets of ion exchange membranes, for example, in an electrodialysis device. Spacers so made may be of monotype material, or may be of mixed or patterned exchange type. Monotype material may be useful as the concentrate cell spacer/filling in certain constructions to provide an assured threshold of electrical conductivity, whereas monotype, mixed-type, or block-pattern screen may be used in the dilute cells, to provide an appropriate demineralizing effect for an intended feed fluid and desired removal requirements.

In one preferred embodiment, strands of both cation- and anion-exchange material are employed to form a screen with a strand pattern or weave configured such that the exchange material of one type lies all on one side (e.g., the anion exchange strands on one side and cation exchange on the other), or may be configured such that strands of each type follow wavy paths from one side to the other, or may be configured in bunches of monotype or mixed strands in a particular pattern (with respect to the flow path through the device). For example, the bunches may be arranged such that a fluid first passes over entirely cation exchange (or anion exchange) strands, then over another bunch of mixed or monotype strands. The latter construction is useful in regulating fluid treatment to shift pH, to soften or to otherwise condition the flow, or control the regions at which passage of particular species into occurs from the dilute or into the concentrate flows.

It is preferred that the strand material of the present invention be cured in an atmosphere free of destructive agents, such as oxygen. Thus, for example, the strand 1 may be coated (by spraying, by dipping, by passage through the nose of a coating extruder, or otherwise, and then pass through a nitrogen-blanketed heating zone to form the exchange strand 10. The cured strand may then be spooled and stored for a later fabrication step (such as screen weaving) or may be passed to further fabrication steps (such as fiber chopping, electrofloculation, spinning, rope- or twine-making, or other textile-, rope-, or screen type fabrication process.

In addition to the bulk uses and devices described above, the exchange strands of the present invention may be formed into a great number of new structures adapted from prior art non-exchange components. Thus, for example, when formed into a depth filter, functionalized strands of the present invention offer an easy-to-handle element having a combination of physical integrity, dimensional flexibility, defined exchange capacity and durability.

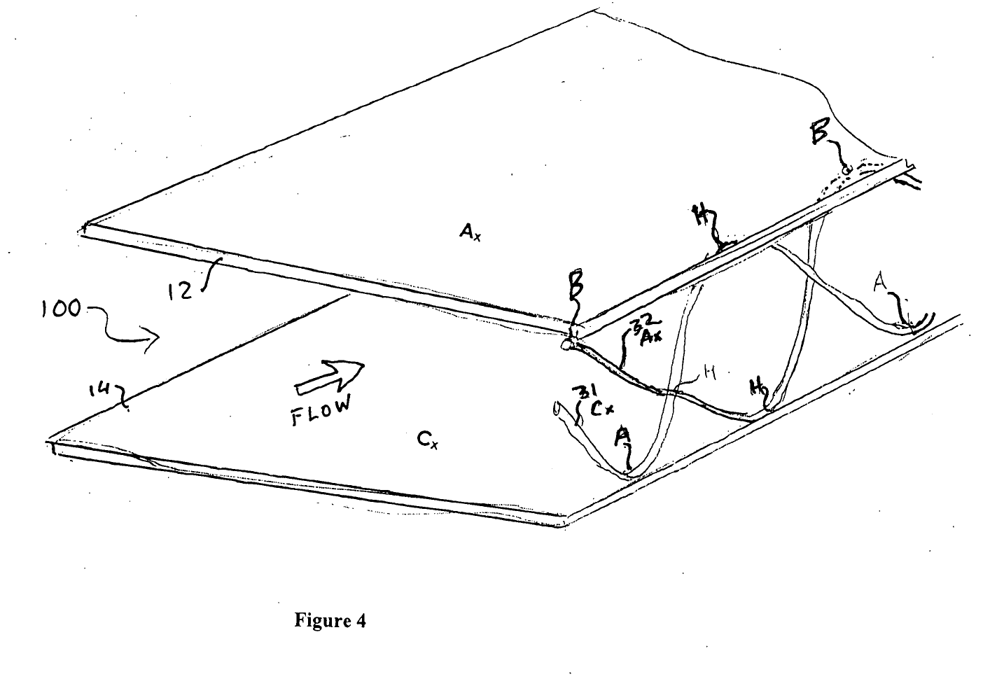

FIG. 4 illustrates a construction details for improved electrodialysis devices based on a spacer comprised of strands of material formed into a generally sheet-like mat or screen, wherein individual strands extend transverse to the plane of the sheet to provide a well-defined thickness dimension, and the strands are formed of exchange-functionalized material. The spacer maintains a flow space between two membranes wherein the transverse strands directly contact one or both membranes. The strands extend at least part way across the central fluid region so that they capture ions—cations or anions—and each strand acts as an ion-transfer “pipe” for conducting captured ions in a transverse direction directly to a respective one of the adjacent membranes. The use of such a transverse strand structure enables ion capture and transport to proceed without a break in the ion conduction path entirely across the cell thickness, while still providing heterojunctions at contact points of dissimilar fibers or of a fiber and a dissimilar membrane, that continuously regenerates the exchange material to maintain its activity. The strands, and the screen generally, may be formed to minimize the stationary fluid layer that occurs at their surface, for example, by projecting transversely across the fluid flow. In ED operation this surface turbulence effect increases the limiting current density and the effective rate of ion capture from the surrounding flow. The described screen also constitutes a well defined structural element that serves as a spacer to distribute support for the adjacent membranes, providing an open and well defined flow space between adjacent membranes.

In one embodiment, wavy transverse strands of the spacer bear against a membrane of like functionality on one side, while forming a splitting junction at the membrane of opposite type at the other side, and/or a splitting junction at an intermediate position (e.g., at a position contacting a strand of opposite exchange type). Preferably, the strand has a bulk stiffness or strand bending stiffness that is comparable to or higher than the modulus of the adjacent membrane, so that peaks of the strand contact and bear against the membrane surface, forming an improved ion-conductive contact therewith. The spacer sheet so formed may be used in an EDI device to replace a conventional exchange bead filling, acting both as a spacer and as an exchange medium, but providing a generally more open, higher-flow pathway through the cell than occurs with an exchange bead filling, while providing a high rate of capture and a high rate of ion conductance to remove the captured ions, as well as a mechanism for continuous regeneration of the exchange strands. It also permits greater efficiencies of device manufacture, allowing the EDI stack or spiral to be fabricated by a simple layering procedure, without loading any exchange beads, resulting in a construction that is simple to build, free of dimensional variations, and easy to service or rebuild.

When used as an intermembrane spacer for electrodialysis, several sheets of the spacer material may be “stacked” to form a flow cell spacer of desired thickness, and cells of arbitrary dimension are readily constructed and assembled. The strands of one layer may contact like-type strands of the next layer to collectively provide a continuous, direct path of same-type ion exchange material running to the adjacent membrane. The “weave” of the mat may also be arranged so that strands of one type in a first layer possess at least some points of contact with strands of opposite type in an adjacent layer, while the adjacent membranes are each only contacted by same-type strands of exchange material. This prevent excessive generation of hydroxyl or hydronium ions at the membrane surface. Different strand diameter and mesh pitch or dimension may be employed for treating fluids of different viscosity or concentration to optimize treatment throughput and removal rate, or minimize fouling or flow obstruction.

Physically, the construction of an EDI unit with exchange-functional transverse-path spacer elements of the present invention involves flow mechanics comparable to the membrane/spacer constructions of commercial (unfilled) electrodialysis (ED) stacks having inert spacers, but offers enhanced electrochemical capacity and electrodeionization mechanisms because of the large surface area of exchange-functionalized material projecting into the flow path, and the direct exchange conduction pathways running transversely and directed to the adjacent membrane surfaces. Treatment rates therefore approach the rates achievable with filled-cell EDI stacks. As such, spacers of the present invention, and devices built with such spacers, may be employed for any treatment application, such as treatment of a food or fermentation product stream, that has been amenable to electrodialysis processes in the past, including those applications which have resisted treatment by filled-cell EDI due to fouling, flow congestion or other problems.

FIG. 4 schematically shows a construction for an electrodeionization device of the type wherein one or plural flow cells 100 are positioned between electrodes in a stack or wound membrane unit. Electrodes (not shown) are typically positioned at the ends (of the stack) or inside and outside (of wound cells) to drive ion transport. Each cell 100 is bounded by membranes, such as an anion exchange membrane 12 and a cation exchange membrane 14, and the device is configured such that a fluid to be treated flows in the space between the membranes. In simple electrodialysis (ED) devices, a screen spacer maintains a narrow open space between the two membranes, whereas in common filled cell electrodeionization (EDI) devices, a permeable packing of ion exchange beads, felt or other material, optionally with a rib or frame structure, maintains the membrane separation. The exchange filling presents a larger capture area to the fluid, and it also continuously regenerates as polarization rises, so that the filled cell EDI construction offers capture activity comparable to a bed of exchange beads, yet without the requirements for the strong chemical regenerants that those beds require.

In accordance with a principal aspect of the present invention, the central flow region of the cells 100 of the electrodialysis device contains a screen comprised of wavy strands of ion exchange material and that extend across the cell and contact at least one and preferably both membranes. Only two strands, 31, 32 are shown, but it will be understood that the spacer will comprise a regular two-dimensional sheet of such strands, arranged in a woven, chain-link or other configuration. For example, warp and woof strands may be of opposite exchange type, and may be woven in a simple alternating over-and-under weave. As shown, the strand 31 (illustratively formed of cation exchange material Cx) runs transversely across the cell thickness dimension, contacting and supporting the cation exchange membrane 14 at points A, thus acting as a direct ion conduction pipe for cations stripped from the fluid passing through the cell. Similarly, the anion exchange strand 32 extends across the flow path while contacting and supporting the anion exchange membrane 12 at a regular number of points B. The points A, B are each homojunctions, where ions may pass directly from an exchange strand into the appropriate exchange membrane and be removed from the flow. Moreover, the strands constitute continuous paths, so that captured material does not get re-emitted, drift in the flowing fluid, and become recaptured, but instead, proceeds quickly out of the flow. The exchange strands may be formed by any suitable technology, but when formed by a coating/curing method as described above and fabricated into a sheet of screen or spacer, processes such as weaving may advantageously be used. When the functional material is coated on a fiber, the resulting body has a short diffusion path that offers enhanced performance in EDI for cleaning, store-and-release and normal operating stages.

Returning to FIG. 4, the strands 31, 32 in this embodiment each also contact the membrane of opposite type, and/or contact the strand of opposite exchange type, creating heterojunctions H. Water splitting may occur at the heterojunctions, promoting regeneration of the exchange material, while generally allowing efficient flow of the captured ions along the strands of appropriate type and into the corresponding appropriate membranes.

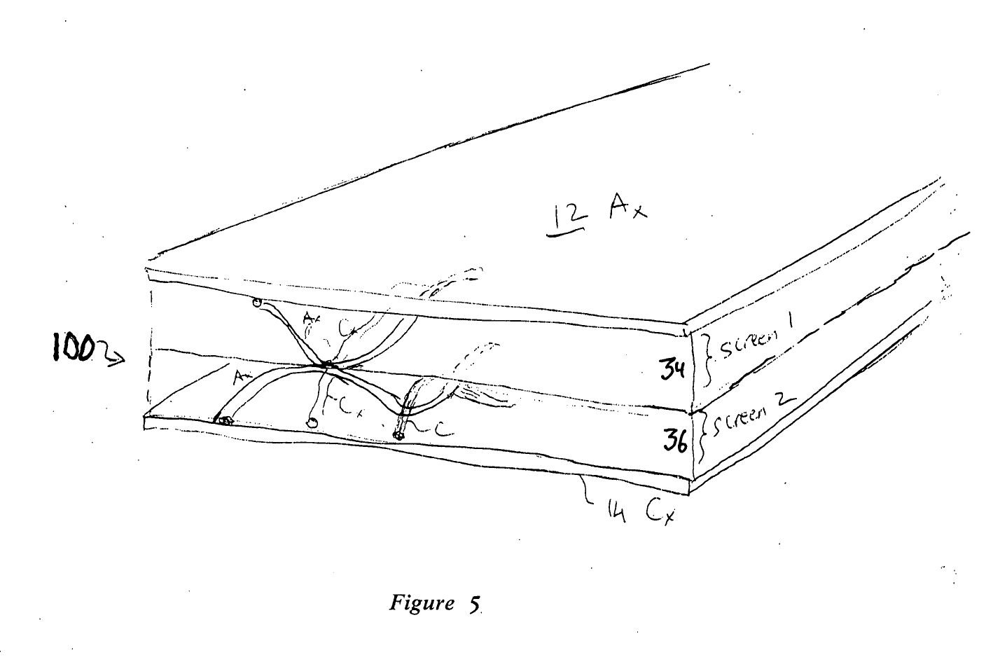

FIG. 5 illustrates another embodiment of the invention, wherein a cell 10 is bounded by anion exchange membrane 12, denoted Ax, and a cation exchange membrane 14, denoted Cx. In this embodiment, two layers of screen 34, 36 are stacked to achieve a greater thickness. As before, each layer of screen has a defined thickness, with individual strands extending across the thickness direction of the cell. Preferably each layer has both anion exchange strands Ax and cation exchange strands Cx, and the weave or frequency of the strands is also preferably such that the cation exchange strands of layer 34 contact cation exchange strands of layer 36, and also the anion exchange strands of layer 34 contact anion exchange strands of layer 36. Thus, any species captured in either layer proceeds within an exchange conduction pipe or strand, along a direct and unbroken path of exchange material, directly into the appropriate membrane 12 or 14. As before, a number of heterojunctions H assure that the spacer exchange material remains in a sufficiently regenerated and active form during operation.

Thus, strand of like exchange type contact each other to form ion-transport paths directly across the flow space into the adjacent membranes. It is not necessary that alignment be exact, because in this construction, the arrangement of anion exchange and cation exchange material is highly regular, as dictated by the weave, so that even if, say, cations are ejected at a heterojunction, such re-emission occurs at most one time, and there is a cation exchange strand immediately adjacent that may complete the removal and transport task.

The exchange spacers of the present invention may have the same open flow-dynamic characteristics as the inert screen spacers conventionally employed in electrodialysis stacks or spiral wound UF, NF or MF modules that have long been employed for processing fluids such as whey, fermentation product streams or other difficult to treat biological or organic streams. Yet because the screen itself is formed of exchange material arranged to contact membranes, provide high levels of heterojunctions, and also continuous homotype transport paths, the removal cells of the present invention operate with the high ion-stripping and removal rates customarily associated with packed cell EDI constructions. They may thus be employed to treat lower-conductivity feed stocks of organic or biologically-derived fluid. Spacers in accordance with the present invention may be stacked two or more deep to provide a desired cell thickness, and the pitch or weave may be varied in spacing to assure a fit of the like-type strands and/or to provide a controlled amount of heterojunctions. The weave may also be varied to provide the equivalent of a monotype material in one or more bands or regions, corresponding to the layered, banded or zebra exchange bead fillings of classical EDI devices or exchange beds. In addition, when stacked, the spacers may be fabricated and arranged to allow contact of the each membrane only by strands of like exchange-type.

The invention being thus described, further variations and modifications of the basic steps described herein, as to methods of forming exchange strands, novel devices employing the exchange strands, and methods of use will occur to those skilled in the art. All such variations, modifications and uses of the methods and materials described herein are considered to be within the scope of the invention, as defined by the claims appended hereto and their equivalents.

1. An ion exchange vessel or bottle device with first and second ports for entry and exit of a feed fluid and comprising a strand of ion exchange material filling a region within said device to remove ions from the feed fluid.

2. An exchange component comprising a spacer comprised of strands of ion exchange material, the strands being formed into a sheet having a first side and a second side and presenting a defined thickness dimension between the first and the second side, strands extending transversely between the first and second side, such that the strands bear against an exchange membrane positioned at one of said sides and form direct ion conduction pathways to said exchange membrane for ions captured by the strands, and the strands also forming splitting junctions to regenerate the ion exchange material of the strands whereby the component functions as a spacer and as an ion exchange filling of enhanced flow and defined capture characteristics.

3. A spacer for an electrodialysis device comprising the component of claim 2.

4. The spacer of claim 3, comprising plural layers.

5. The component of claim 2, comprising short diffusion path strands.

6. An electrodialysis device for treating an organic or biologically-derive fluid stream, wherein the electrodialysis device includes ion exchange membranes and a spacer separating the membranes, the spacer having strands of ion exchange material contacting and supporting an ion exchange membrane and extending transversely into an intermembrane flow space to capture ions from the fluid stream and provide a direct conduction path to the membrane for enhanced separation activity while providing non-occluding flow.
